(19) United States
(12) Patent Application Publication
(10) Pub. No.: US 2012/0198242 A1
(43) Pub. Date: Aug. 2, 2012

(54) DATA PROTECTION WHEN A MONITOR DEVICE FAILS OR IS ATTACKED

(75) Inventors: William J. Dalzell, Parrish, FL (US); James L. Tucker, Clearwater, FL (US); Kenneth Henry Heffner, Largo, FL (US)

(73) Assignee: HONEYWELL INTERNATIONAL INC., Morristown, NJ (US)

(21) Appl. No.: 13/017,633

(22) Filed: Jan. 31, 2011

(51) Int. Cl. G06F 12/14

(52) U.S. Cl. 713/190; 711/163; 711/E12.092

(57) ABSTRACT

In some examples, a system includes a data storage device that stores data and a monitor device that monitors a physical domain in which the data storage device is located and conditions access to data stored by the data storage device based on communication between the monitor device and the data storage device. In some examples, the system is configured to impede access to the data when at least one of operation the monitor device fails or the monitor device is attacked. Additionally, in some examples, the monitor device is configured to restrict access to the data when the monitor device is engaged and an attacker attempts to access the data storage device directly.

### STATEMENT REGARDING FEDERALLY SPONSORED RESEARCH OR DEVELOPMENT

This invention was made with Government support under Government Contract # FA8650-04-C-8011 awarded by the Air Force. The Government has certain rights in the invention.

### TECHNICAL FIELD

The disclosure relates to systems for protecting data stored on a data storage device.

### BACKGROUND

Systems for protecting data stored on data storage devices may include a monitor device that monitors a physical domain in which the data storage device is disposed. The monitor device may receive a signal from at least one sensor, such as a magnetic sensor, a motion sensor, a pressure transducer, an acoustic sensor, an optical sensor, or the like, and may determine the status of the physical domain based on the received signal. In some examples, the monitor device may restrict access to data stored on the data storage device when the signal received from the at least one sensor indicates a change in the condition of the physical domain. For example, the monitor may impede physical access to the data storage device, e.g., by locking a door to the physical domain, or the monitor may impede electronic access to the data storage device, e.g., by deleting the data or deleting a decryption key used to decrypt encrypted data stored on the data storage device.

### SUMMARY

In general, the disclosure is directed to protecting data stored by a data storage device when operation of a monitor device, which may monitor a physical domain in which the data storage device is disposed, fails or the monitor device is attacked. In some examples, the operational failure of the monitor device may be a failure that is due to a physical or electronic attack on the monitor device by an attacker, while in other examples, the failure of the monitor device may be due to loss of power, an error in firmware or software executed by the monitor device, or the like. For example, access to the data stored by the data storage device may depend on communication between the monitor device and the data storage device. Thus, if operation of the monitor device fails or the monitor device is attacked, the system may impede access to the data stored by the data storage device.

In some examples, the system may provide protection to data stored on the data storage device in at least two manners. First, the system may impede access to the data when the monitor device is attacked, as described above. Additionally, the monitor device may monitor a physical domain in which the data storage device is disposed and may impede access to the data stored on the data storage device when the monitor device is engaged (e.g., turned on). This may provide protection to the data stored on the data storage device in circumstances in which an attacker attempts to directly access (e.g., physically or electronically) the data storage device. In this way, in some examples, the system may offer at least two layers of protection to the data stored on the data storage device: protection from direct attacks on the data storage device and protection from attempted or successful attacks on the monitor device or failure of the monitor device.

In one aspect, the disclosure is directed to a system that includes a data storage device that stores data and a monitor device that monitors a physical domain in which the data storage device is located and conditions access to data stored by the data storage device based on communication between the monitor device and the data storage device. According to this aspect of the disclosure, the system is configured to impede access to the data when at least one of operation of the monitor device fails or the monitor device is attacked.

In another aspect, the disclosure is directed to a method that includes detecting an attack on a monitor device via at least one of a sensor or a software or firmware program. The method also includes rendering a data storage device communicatively coupled to the monitor device unable to access a key when the attack on the monitor device is detected. According to this aspect of the disclosure, when the data storage device cannot access the key, access to encrypted data stored on the data storage device is impeded.

In an additional aspect, the disclosure is directed to a system that includes an enclosure, a sensor configured to detect breach of the enclosure, a data storage device, and a monitor device enclosed within the enclosure. According to this aspect of the disclosure, the monitor device conditions access to data stored by the data storage device based on communication between the monitor device and the data storage device, and the system is configured to impede access to the data when at least one of operation the monitor device fails, the monitor device is attacked, or the enclosure is breached.

In another aspect, the disclosure is directed to a computer readable storage medium, which may be an article of manufacture. The computer readable storage medium comprises computer readable instructions for execution by a processor. The instructions cause a programmable processor to perform any part of the techniques described herein. The instructions may be, for example, software instructions, such as those used to define a software or computer program. The computer-readable medium may be a computer-readable storage medium such as a storage device (e.g., a disk drive, or an optical drive), memory (e.g., a Flash memory, read only memory (ROM), or random access memory (RAM)) or any other type of volatile or non-volatile memory that stores instructions (e.g., in the form of a computer program or other executable) to cause a programmable processor to perform the techniques described herein. The computer-readable medium may be nontransitory.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram that illustrates an example of a system that protects data stored by a data storage device.

FIG. 2 is a conceptual block diagram that illustrates another example of a system that protects data stored by a data storage device.

FIG. 3 is a functional block diagram that illustrates an example of a monitor device.

FIG. 4 is a flow diagram that illustrates an example of a technique according to which a monitor device may protect data stored by a data storage device when the monitor device is attacked.

FIG. 5 is a flow diagram that illustrates another example of a technique according to which a monitor device may protect data stored by a data storage device when an attacker attempts to directly access the data storage device.

FIG. 6 is a conceptual block diagram that illustrates another example of a system that protects data stored by a data storage device.

### DETAILED DESCRIPTION

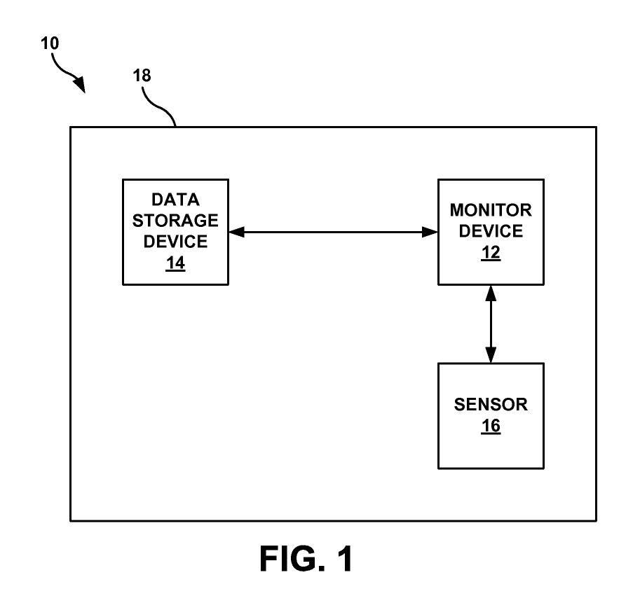

FIG. 1 is a conceptual block diagram that illustrates an example of a system that protects data stored by a data storage device. In general, FIG. 1 illustrates a system 10 that includes a monitor device 12 and a data storage device 14. Monitor device 12 is communicatively coupled to a sensor 16. Monitor device 12, data storage device 14, and sensor 16 are located within a physical domain 18, which may be, for example, a building, a room, a cabinet or other storage container, an electronics enclosure, or the like. In various examples, if physical domain 18 is a building, the building may be a commercial, industrial, governmental, military, or residential building. In some examples, the physical domain 18 may be portable, e.g., a briefcase or other relatively easily movable enclosure.

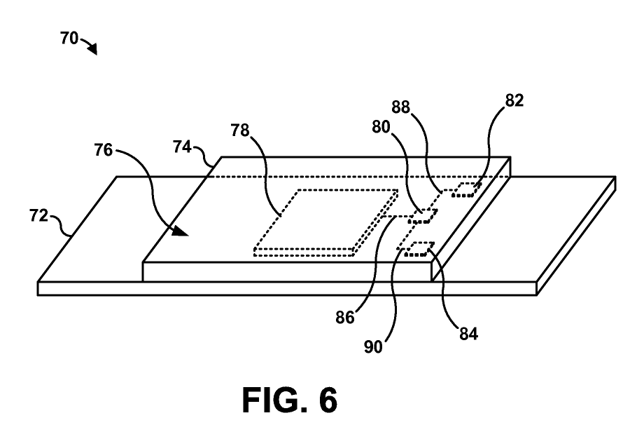

As described below with respect to FIG. 6, in some examples, physical domain 18 may be defined by an enclosure (e.g., the enclosure may have a defined volume) that encloses an electronic system, such as a server, personal computer, or the like. In other examples, physical domain 18 may be defined by an enclosure that at least partially encloses a data storage device 14 within an electronic system, e.g., the enclosure may at least partially enclose the entire electronic system or may at least partially enclose a component (e.g., an integrated circuit) of the electronic system.

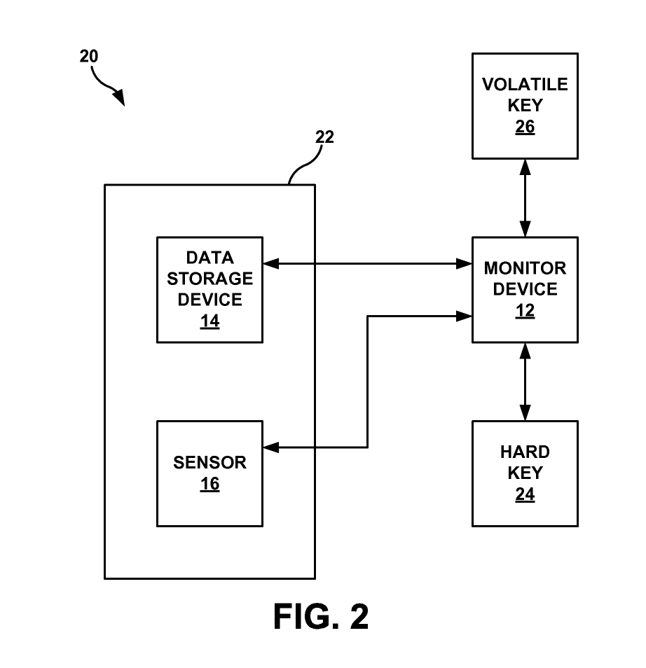

Although FIG. 1 illustrates monitor device 12, data storage device 14, and sensor 16 as each being located within physical domain 18, in other examples, monitor device 12 may be located outside of physical domain 18 (see FIG. 2). For example, when physical domain 18 is an electronics enclosure, monitor device 12 may be located external to the electronics enclosure, while data storage device 14 is located within the electronics enclosure. In some examples, monitor device 12 may be located within the electronics enclosure, as illustrated in FIG. 6. Sensor 16 may be located within physical domain 18, along a perimeter of physical domain 18 (either inside the perimeter or outside the perimeter), or outside of physical domain 18. For example, when physical domain 18 includes an electronics enclosure, sensor 16 may be positioned inside of or outside of the electronics enclosure, such as within a room in which the electronics enclosure is located. As another example, when physical domain 18 includes a room within a building, sensor 16 may be positioned outside the room and within the building, or outside the room and the building in which the room is located.

Data storage device 14 may be any medium (e.g., a tangible, nontransitory medium) capable of storing data. In some examples, data storage device 14 comprises a magnetic data storage device, e.g., a hard disc drive (HDD) or a magnetic tape drive. In other examples, data storage device 14 may be a solid state data storage device, e.g., a solid state drive (SSD), a form of computer memory, such as dynamic random access memory (DRAM), static random access memory (SRAM), read-only memory (ROM), programmable read-only memory (PROM), erasable programmable read only memory (EPROM), Electrically Erasable Programmable Read-Only Memory (EEPROM), flash memory, ferroelectric random access memory (FeRAM), magnetoresistive random access memory (MRAM), or the like. In some examples, data storage device 14 may be integrated into a larger computing system, such as a personal (laptop or desktop) computer, a workstation, a server, or the like. In other examples, data storage device 14 may be a separate device communicatively coupled to a computing system, such as an external HDD or SSD, a universal serial bus (USB) flash drive, or the like.

Data storage device 14 is configured to store data (e.g., intellectual property) that a user may wish to be protected. In some examples, to aid in protecting the data, the data may be encrypted and may require a key to decrypt the data into intelligible form (e.g., a form that is understandable/intelligible to a human or machine), which, along with system 10, may help protect the stored data from undesirable access to the data. In other examples, the stored data may not be encrypted, and protection of the data may be effectuated primarily by system 10 and the location of data storage device 14 within physical domain 18.

System 10 is configured to protect data stored by data storage device 14 by impeding access to the data by an unauthorized user (also referred to herein as an attacker). In some examples, monitor device 12 is able to be engaged and disengaged (e.g., turned on and off, respectively). When disengaged, monitor device 12 may not monitor the output of sensor 16, or may monitor the output of sensor 16 but may not perform any action based a signal received from sensor 16. When engaged, however, monitor device 12 monitors signals received from sensor 16, and may perform an action based on a signal received from sensor 16.

In some examples, sensor 16 comprises any one or more sensors that monitor at least one parameter of physical domain 18. The one or more sensors may each generate a signal indicative of at least one parameter of physical domain 18, and a processor of system 10 may detect unauthorized access to physical domain 18 based on the signal. For example, sensor 16 may include a magnetic sensor that monitors a status of a door, window, or other ingress/egress point of physical domain 18, e.g., whether the ingress/egress point is in an open state or a closed state. As another example, sensor 16 may include a motion sensor that detects motion within physical domain 18. In some examples, sensor 16 may include a pressure transducer, which may sense pressure at one or more points within physical domain 18, e.g., to determine whether a person or other object is standing on a floor of physical domain 18. Sensor 16 may additionally or alternatively include an acoustic sensor, which is configured to generate a signal indicative of sounds within or about physical domain 18, e.g., breaking of glass, such as a window or door into physical domain 18. Sensor 16 also may include an optical sensor, such as a charge coupled device (CCD), an active pixel sensor (e.g., a complementary metal-oxide-semiconductor (CMOS) sensor), or an infrared sensor array. In some examples, sensor 16 may additionally or alternatively include a piezoelectric torsion transducer, a tensioner, or a chemical transducer.

In some examples, system 10 includes a single type of sensor 16 and/or a single sensor 16. In other examples, system 10 may include multiple types of sensors 16 and/or multiple sensors 16. Additionally, while sensor 16 is illustrated in FIG. 1 as being physically separate from monitor device 12, in some examples, at least one sensor 16 may be physically integrated with monitor device 12. For example, at least part of sensor 16 may be located at least partially within a housing of monitor device 12. In other examples, monitor device 12 and sensor 16 may be physically separate devices. As described above, sensor 16 may be located in any suitable location (e.g., within physical domain 18, along a perimeter of physical domain 18, or outside of physical domain 18) that is appropriate to monitor various characteristics of physical domain 18 and/or an area near physical domain 18. Characteristics of physical domain 18 may include, for example, a presence or an absence of a person or an object within or near physical domain 18, movement or absence of movement within or near physical domain 18, a sound or an absence of sound within or near physical domain 18, a state (e.g., open or closed state) of a door, window or other ingress point to physical domain 18, or the like.

In some examples, monitor device 12 is communicatively coupled to sensor 16. For example, sensor 16 may be communicatively coupled to monitor device 12 via a wired connection, e.g., an electrically conductive wire or an optical cable. In other examples, monitor device 12 and sensor 16 may be communicatively coupled via a wireless communication technique. Examples of local wireless communication techniques that may be employed to facilitate communication between sensor 16 and monitor device 12 include, but are not limited to, radio frequency (RF) communication according to the 802.11 or Bluetooth specification sets, infrared communication, e.g., according to the IrDA standard, or other standard or proprietary telemetry protocols.

Monitor device 12 receives signals from sensor 16 and, in some examples, determines, based on the signals, whether a predetermined event is occurring or has occurred in a location in which sensor 16 covers. As described above, sensor 16 may be located within physical domain 18, along a perimeter of physical domain 18, and/or outside of physical domain 18; accordingly, in various examples, sensor 16 may sense predetermined events that occur within physical location 18, along the perimeter of physical domain 18, or outside of physical domain 18. The predetermined event may include an event that suggests or indicates that an attacker (e.g., a human attacker) is attempting to access physical domain 18 and/or data storage device 14. For example, sensor 16 may include a magnetic sensor attached to a door that permits access to physical domain 18, and monitor device 12 may determine when the signal generated by sensor 16 indicates that the door is in an open state. The open state may indicate that physical domain 18 has been physically accessed, and monitor device 12 may store instructions that indicate that no access to physical domain 18 is permitted, such that the open state of the door indicates that an attacker is attempting to access physical domain 18 and/or data storage device 14.

As another example, sensor 16 may include a pressure sensor located on a floor of physical domain 18, and monitor device 12 may determine when an object or person is within physical domain 18 based on the signal received from the pressure sensor. If monitor device 12 stores instructions that indicate that no access within physical domain 18 is permitted, monitor device 12 may determine that, based on the presence of an object or person within physical domain 18, an attacker is attempting to access physical domain 18 and/or data storage device 14. Monitor device 12 may determine other conditions of physical domain 18 or an area outside of physical domain 18 based on signals received from different sensors, as described above.

To facilitate the determination of whether a predetermined event has occurred or is occurring, monitor device 12 may in some examples determine a baseline value or threshold value for the signal received from sensor 16, e.g., when monitor device 12 is first engaged and physical domain 18 is known to not be breached by an attacker. In some examples, monitor device 12 determines the baseline value or threshold value based on a characteristic (e.g., an amplitude value, a frequency value, a frequency domain value, and the like) extracted from the signal received from sensor 16, e.g., may determine an average, median, peak or lowest value of the received signal over some time duration.

As another example, monitor device 12 may determine a running average of a signal received from sensor 16 over a window of time, and may determine that a predetermined event has occurred when the signal received from sensor 16 varies from the running average by more than a predetermined amount. In other examples, characteristics of the signal received from sensor 16 that may trigger an action by monitor device 12 may be predetermined and stored in a memory of monitor device 12.

When monitor device 12 determines based on the signal received from sensor 16 that a predetermined event has occurred or is occurring, e.g., an discrete event, such as breaking of glass, occurred in the past or an event, such as presence of a person in physical domain 18, is ongoing, monitor device 12 may perform an action to protect data stored on data storage device 14. For example, monitor device 12 may generate an alarm, which may include an audible alarm, a visual alarm, a somatosensory alarm, or the like, and may additionally or alternatively communicate an alarm to security persons, police, or the like. The alarm may be triggered for perception near physical domain 18 or remote from physical domain 18.

In some examples, monitor device 12 may additionally or alternatively perform an action to physically secure data storage device 14, such as causing a door to a room within physical domain 18 (when physical domain 18 is a building) in which data storage device 14 is located to lock. As another example, monitor device 12 may physically secure data storage device 14 by causing an electronic enclosure in which data storage device 14 is disposed to lock.

When monitor device 12 determines that a predetermined event is occurring or has occurred, monitor device 12 may in some examples perform an action (e.g., directly perform the action or control another device to perform the action) to electronically secure the data stored on data storage device 14 in addition to or as an alternative to an alarm or physically securing data storage device 14. For example, monitor device 12 may communicate an instruction to data storage device 14 that causes data storage device 14 to delete the stored data. As another example, monitor device 14 may cause a key used to decrypt the data to be deleted or rendered inaccessible to data storage device 14. In some examples, access of the data stored on data storage device 14 may be contingent on communication between data storage device 14 and monitor device 12, e.g., data storage device 14 may retrieve at least one encryption key from monitor device 12 to decrypt the data, and monitor device 12 may disable communication between monitor device 12 and data storage device 14 upon determining that the predetermined event has occurred or is occurring.

Attackers attempting to gain access to the protected data may attempt to disable the monitor device 12 in order to circumvent the protection afforded by monitor device 12 to the data stored by data storage device 14. In existing systems, when monitor device 12 is disabled, the data stored on data storage device 12 may be less protected or substantially unprotected. In accordance with aspects of this disclosure, system 10 provides protection to data stored by data storage device 14 when monitor device 12 is attacked or when operation of monitor device 12 fails, such as when monitor device 12 loses power or is otherwise rendered incapable of monitoring physical domain 18 and/or data storage device 14. System 10 may provide protection to data stored by data storage device 14 when monitor device 12 detects an attempted attack on monitor device 12 and/or when an attacker makes a successful attack on monitor device 12 (e.g., by modifying operation of monitor device 12, disabling monitor device 12, or damaging monitor device 12). For example, monitor device 12 may condition access to data stored by data storage device 14 based on communication between monitor device 12 and data storage device 14. In this way, system 10 can include at least two levels of protection for data stored by data storage device 14: protection of data stored by data storage device 14 (e.g., by encrypting the data and by protecting data storage device 14 with monitor device 14) when data storage device 14 is directly attacked, and protection of access to the data stored by data storage device 14 when operation of monitor device 12 fails or when monitor device 12 is attacked.

In some examples, an attacker attempting to access the data stored by data storage device 14 may be aware that monitor device 12 is monitoring physical domain 18 or an area near physical domain 18 to protect data storage device 14, and may attempt to disable monitor device 12 to facilitate access to physical domain 18 and/or to data stored by data storage device 14. The attacker may attack monitor device 12 with a physical attack and/or an electronic attack. A physical attack may include, for example, physical damage to or destruction of monitor device 12, may include cutting off a power source to monitor device 12, or may include attack of one or more communication connections between monitor device 12 and another device. For example, the attacker may sever a wired communication link between monitor device 12 and sensor 16, between monitor device 14 and data storage device 14, and/or between monitor device 12 and another device, e.g., an external device that receives an alarm generated by monitor device 12.

An electronic attack may include, for example, damage or disabling of one or more functions performed by monitor device 12 via a modification of software or firmware executed by a processor of monitor device 12. For example, the person attacking monitor device 12 may disable communication between monitor device 12 and another device by modifying or disabling a software or firmware module that the processor executes to communicate with other devices. In some examples, an electronic attack may additionally or alternatively disabling sensor 16 and/or modifying data received by monitor device 12 from sensor 16.

Regardless of the precise nature of the attack on monitor device 12, system 10 (e.g., including monitor device 12 and data storage device 14) is configured so that access to the data stored by data storage device 14 is conditioned based on communication between monitor device 12 and data storage device 14, and access to the data is impeded when monitor device 12 is attacked or operation of monitor device 12 otherwise fails. As used herein, impeding access to data stored by data storage device 14 may include, for example, maintaining the data in an encrypted state and hindering (e.g., preventing) access to the key used to decrypt the data, e.g., by disabling communication with a device that stores the key or by deleting the key; actively or passively deleting the data; physically securing data storage device 14, e.g., within a locked room; or the like.

In one example, data storage device 14 is configured to communicate with monitor device 12 before allowing access to the data stored by data storage device 14. For example, when a user attempts to access data stored by data storage device 14, data storage device 14 may communicate with monitor device 12 to receive a known signal from monitor device 12 before allowing access to the data. As another example, data storage device 14 may periodically communicate with monitor device 12 to receive a known signal from monitor device 12, and if data storage device 14 does not receive the known signal from monitor device 12, may restrict access to data stored by data storage device 14. Thus, if operation of monitor device 12 fails, e.g., due to loss of power or an attack, or if an attacker physically attacks monitor device 12 or a communication link between monitor device 12 and data storage device 12 and disables communication between monitor device 12 and data storage device 14, data storage device 14 may not be able to communicate with monitor device 12. In response, data storage device 14 may restrict access to the data, e.g., by not allowing any access to the data, by deleting the data, or by maintaining the data in an encrypted state, which may impede the attacker (or another device or person) from accessing the data in a meaningful (e.g., intelligible) format. Similarly, if an attacker electronically attacks monitor device 12 and modifies or disables a communication module executed by a processor of monitor device 12 to communicate with data storage device 14 and/or other external electronic devices, data storage device 14 may not be able to communicate with monitor device 12 and may restrict access to the data, which may impede the attacker (or another device or person) from accessing the data.

In other examples, monitor device 12 may detect a physical or electronic attack and may perform an action in response to detecting the attack. For example, monitor device 12 may include one or more sensors (which may include sensor 16) that are configured to detect a physical attack, e.g., an accelerometer to detect motion or orientation of monitor device 12, a magnetic sensor to detect whether a housing or enclosure of monitor device 12 is opened or closed, a pressure transducer to detect a force exerted on monitor device 12, or the like. Monitor device 12 may additionally or alternatively include a software or firmware program executed by a processor of monitor device 12 that detects an electronic attack of monitor device 12.

Regardless of how monitor device 12 detects the attack on device 12 or whether the attack is a physical attack or an electronic attack, monitor device 12 may perform an action to impede access to the data stored by data storage device 14 when device 12 detects the attack. For example, when access to data stored by data storage device 14 is conditioned on communication between data storage device 14 and monitor device 12 (as described above), monitor device 12 may disable communication between data storage device 14 and monitor device 12 upon detecting an attack upon monitor device 12. As another example, when data stored by data storage device 14 is encrypted and requires a key stored or accessed by monitor device 12 to be communicated to data storage device 14 to decrypt the data, monitor device 12 may render the key inaccessible to data storage device 14, e.g., by deleting the key or disabling communication between monitor device 12 and data storage device 14 to prevent data storage device 14 from accessing the key.

In other examples, monitor device 12 is configured so that operational failure of monitor device 12, e.g., due to a loss of power, or an attack on monitor device 12 automatically impedes access to the data stored by data storage device 14. For example, monitor device 12 may store a key used to decrypt encrypted data stored by data storage device 14 in a manner that causes the key to be lost automatically upon attack of monitor device 12. Without the key retrieved by monitor device 12 and communicated from monitor device 12 to data storage device 14, the data stored by data storage device 14 may be inaccessible or unintelligible to the attacker. As an example, monitor device 12 may store the key in memory that is positioned within the housing or enclosure of monitor device 12 so that the memory is physically damaged and the key deleted or rendered inaccessible upon physical attack of monitor device 12. As another example, monitor device 12 may store the key in volatile memory that requires periodic refresh to maintain the contents of the memory, i.e., the key. When a failure (e.g., loss of power or a successful physical or electronic attack) causes monitor device 12 to operate incorrectly or turn off, the contents of the memory may no longer be refreshed and the key may thus be automatically deleted.

FIG. 2 is a conceptual block diagram that illustrates another example of a system that protects data stored by a data storage device. The system 20 of FIG. 2 includes data storage device 14 and sensor 16, which are located in a physical domain 22, and monitor device 12. Additionally, system 20 includes a hard key split 24 and a volatile key split 26, which are used to decrypt data stored by data storage device 14, and are accessed by monitor device 12.

Physical domain 22 may be any physical domain, and may include a location similar to those described with respect to physical domain 18 of FIG. 1. For example, physical domain 22 may include a building, a room, a cabinet or other storage container, an electronics enclosure, a briefcase, or the like. As described above with respect to FIG. 1, although sensor 16 is illustrated within physical domain 22, in some examples, sensor 16 may be located along a perimeter of physical domain 22 or may be located outside of physical domain 22. Additionally, while a single sensor 16 is illustrated in FIG. 2, in some examples, system 20 may include a plurality of sensors 16, which may include a single type of sensor or multiple, different sensors.

Data storage device 14 may use hard key split 24 and volatile key split 26 together to decrypt encrypted data stored by data storage device 14. In some examples, when a user requests encrypted data from data storage device 14, e.g., via an input using a user interface of data storage device 14 or another computing device communicatively coupled to data storage device 14, data storage device 14 communicates a request to monitor device 12 for monitor device 12 to access the memory that stores hard key split 24 and the memory that stores the volatile key split 26, retrieve the key splits 24, 26, and communicate the key splits 24, 26 to data storage device 14.

In some examples, hard key split 24 and volatile key split 26 may be stored in different memories or memories of different devices. For example, hard key split 24 may be stored in a memory of monitor device 12 or a memory of a device communicatively coupled to monitor device 12 and is located physically near to monitor device 12. For example, hard key split 24 may be in a USB flash drive carried by a user who wishes to access data stored by data storage device 14. The user may connect the USB flash drive to monitor device 12 using a USB port and may upload the hard key 24 to the monitor device 24. In other examples, the hard key may be stored in a memory of a device that is permanently or semi-permanently communicatively coupled to monitor device 12 and is located physically near to monitor device 12.

In some examples, volatile key split 26 may be stored in a memory of a device that is physically remote from monitor device 12 and/or data storage device 14. In some examples, this may contribute to protection of the data stored by data storage device 14. For example, storing the volatile key split 26 in a memory that is physically remote from monitor device 12 and data storage device 14 may increase the difficulty of an attacker gaining access to both the hard key split 24 and the volatile key split 26, which may impede the decryption of encrypted data, and, therefore, meaningful access to the data, stored by data storage device 14.

Monitor device 12 may be communicatively coupled to the memory that stores volatile key split 26 via a local area network, a wide area network, or a dedicated communication connection. In addition, monitor device 12 may be communicatively coupled to the memory that stores volatile key split 26 via a wired connection, a wireless connection, or a combination of wireless and wired connections.

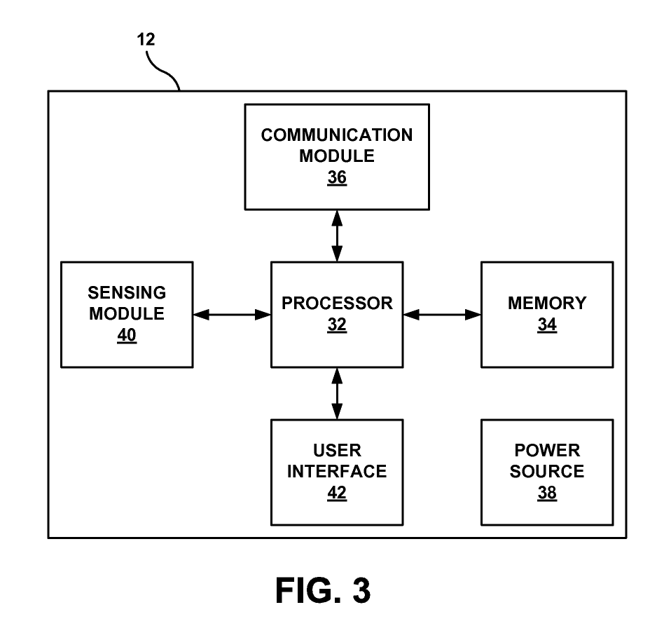

System 20 is configured so that when operation of monitor device 12 fails, such as when monitor device 12 loses power or is successfully attacked, or when monitor device 12 detects a physical or electronic attack, volatile key split 26 is rendered inaccessible to data storage device 14, thus impeding decryption of data stored by data storage device 14. Similar to FIG. 1, in some examples, monitor device 12 may take an action upon detecting an attack on monitor device 12, such as disabling a communication module (e.g., communication module 36 described with respect to FIG. 3) that facilitates communication between monitor device 12 and data storage device 14, for example, by changing a software state to not allow communication with external devices or by changing a physical switch to decouple the communication module (when implemented at least partially in hardware) from a processor of monitor device 12. Alternatively or additionally, monitor device 12 may disable a communication module that facilitates communication between monitor device 12 and the memory that stores volatile key split 26. In some examples, the same communication module within monitor device 12 may facilitate communication between monitor device 12 and the memory that stores volatile key split 26. In such examples, when monitor device 12 disables the communication module, communication between both monitor device 12 and data storage device 14 and monitor device that the memory that stores volatile key split 26 may be disabled.

In other examples, when monitor device 12 detects an attack, monitor device 12 may communicate an instruction to a controller of the memory that stores volatile key split 26 to delete the volatile key split 26. In some examples, the memory that stores volatile key split 26 may comprise volatile memory, and deletion of the volatile key split 26 may be passive, i.e., deletion may be effected by not refreshing the contents of the volatile memory. In other examples, the memory that stores volatile key split 26 may comprise non-volatile memory, monitor device 12 may communicate an instruction to the controller of the memory that causes active deletion, e.g., over-writing, of volatile key split 26.

In some examples, volatile key split 26 may be maintained in the memory based on a periodic communication between monitor device 12 and the controller of the memory that stores volatile key split 26. For example, monitor device 12 may periodically communicate an instruction to the controller of the memory to refresh the contents of the memory to preserve volatile key split 26 (in the case of volatile memory). As another example, monitor device 12 may periodically communicate an instruction to the controller to not delete volatile key split 26 from memory. In either case, the controller may cause volatile key split 26 to be deleted from memory if the controller does not receive the instruction from monitor device 12 at a predetermined time or after a predetermined duration of time following the previous instruction from monitor device 12 that caused volatile key split 26 to be maintained in the memory.

Hence, in some examples, monitor device 12 may cease communicating the instruction to the controller of the memory that stores volatile key split 26 when operation of monitor device 12 fails, such as when monitor device 12 loses power, or when monitor device detects an attack on monitor device 12. This may cause the controller to delete volatile key split 26 from memory. This method of causing deletion of volatile key split may be effective when monitor device 12 fails in one of multiple manners, e.g., if monitor device 12 loses power, if monitor device 12 is no longer able to communicate with the controller of the memory due to physical or electronic severing of the communication link, or if monitor device 12 is physically damaged or destroyed.

FIG. 3 is a functional block diagram that illustrates an example of a monitor device 12. Monitor device 12 may include a processor 32, a memory 34, a communication module 36, a power source 38, a sensing module 40, and a user interface 42. In some examples, monitor device 12 may include additional modules or features, while in other examples, monitor device 12 may not include all of the modules or features described with respect to FIG. 3.

In the example shown in FIG. 3, monitor device 12 includes a user interface 42, which may include input devices that a user can utilize to interact with monitor device 12 and output devices by which processor 32 outputs information for the user to perceive. In some examples, the input devices of user interface 42 include one or more buttons, toggle switches, keys (e.g., a keypad or keyboard), a mouse, a touchscreen, or the like. The output devices of user interface 42 may include at least one of a display, indicator lights, an acoustic transducer, or the like. The user may interact with monitor device 12 to, among other functions, engage and/or disengage monitor device 12, transfer data to memory 34, retrieve information from memory 34, such as a hard key split 24 (FIG. 2), or perceive an alert generated by processor 32 of monitor device 12.

Memory 34 includes computer-readable instructions that, when executed by processor 32, cause monitor device 12 and processor 32 to perform various functions attributed to monitor device 12 and processor 32 herein. Additionally, in some examples, memory 34 may store a key or a hard key split 24 (FIG. 2) that data storage device 12 utilizes to decrypt encrypted data stored by data storage device 12. Memory 34 may include any volatile, non-volatile, magnetic, optical, or electrical media, such as a RAM, ROM, non-volatile RAM (NVRAM), EEPROM, flash memory, MRAM, or any other digital or analog media.

Processor 32 may include any one or more of a microprocessor, a controller, a digital signal processor (DSP), an application specific integrated circuit (ASIC), a field-programmable gate array (FPGA), or equivalent discrete or analog logic circuitry. In some examples, processor 32 may include multiple components, such as any combination of one or more microprocessors, one or more controllers, one or more DSPs, one or more ASICs, and/or one or more FPGAs, as well as other discrete or integrated logic circuitry. The functions attributed to processor 32 herein may be embodied as software, firmware, hardware or any combination thereof.

Processor 32 controls the various modules of monitor device 12 to perform the functions ascribed herein to monitor device 12, processor 32, and the various modules. For example, processor 32 controls sensing module 40 to receive signals from sensor 16 that indicate a condition of physical domain 18, 22. Processor 32 may analyze the signals and determine whether a predetermined event has occurred or is occurring in physical domain 18, 22. For example, sensor 16 may include a magnetic sensor attached to a door, and the magnetic sensor may generate a signal that indicates whether the door is in an open state or a closed state. Processor 32 may receive the signal via sensing module 40 and analyze the signal to determine whether the signal indicates the door is in the open state or the closed state. In some examples, when processor 32 determines, based on the signal, that the predetermined event has occurred or is occurring, e.g., the door is in an open state, processor 32 may perform an action based on instructions stored in memory 34. For example, processor 32 may generate an alarm, may physically secure data storage device 14, e.g., by causing an enclosure within which data storage device 14 is located to lock, or deleting the data stored by data storage device 14. In other examples, sensor 16 may include a different type of sensor that generates a signal indicative of other conditions of physical domain 18, 22, as described above. Additionally, processor 32 may take a different or an additional action when processor 32 determines that a predetermined event has occurred or is occurring, as with respect to FIGS. 1 and 2.

Processor 32 controls communication module 36 to communicate with another computing device, such as data storage device 14 or the memory that stores volatile key split 26 (FIG. 2), via wireless communication techniques or wired communication techniques. Examples of local wireless communication techniques that may be employed by processor 32 and communication module 36 to facilitate communication between monitor device 12 and data storage device 14 include RF communication according to the 802.11 or Bluetooth specification sets, infrared communication, e.g., according to the IrDA standard, or other standard or proprietary telemetry protocols. In some examples, communication module 36 may facilitate communication with another computing device, e.g., the memory that stored volatile key split 26, via a local area network (LAN), a wide area network (WAN), the internet, or another standard or proprietary network.

As described above with respect to FIGS. 1 and 2, in some examples, processor 32, upon detecting an attack on monitor device 12, may disable communication module 36 to prevent communication between monitor device 12 and another device, such as data storage device 14 or the memory that stores volatile key split 26. In other examples, processor 32 may disable communication between monitor device 12 and another device via communication module 36, but may leave communication module 36 enabled to allow communication between monitor device 12 and another, different device, such as an alarm. As described above, processor 32 may disable communication module 36 by, for example, changing a software state to not allow communication with external devices or by changing a physical switch to decouple the communication module (when implemented at least partially in hardware) from a processor of monitor device 12.

Power source 38 delivers operating power to the components of monitor device 12. In some examples, power source 38 may include a battery and a power generation circuit to produce the operating power. In other examples, power source 38 may include a circuit, such as a transformer, connected to an external electrical power source.

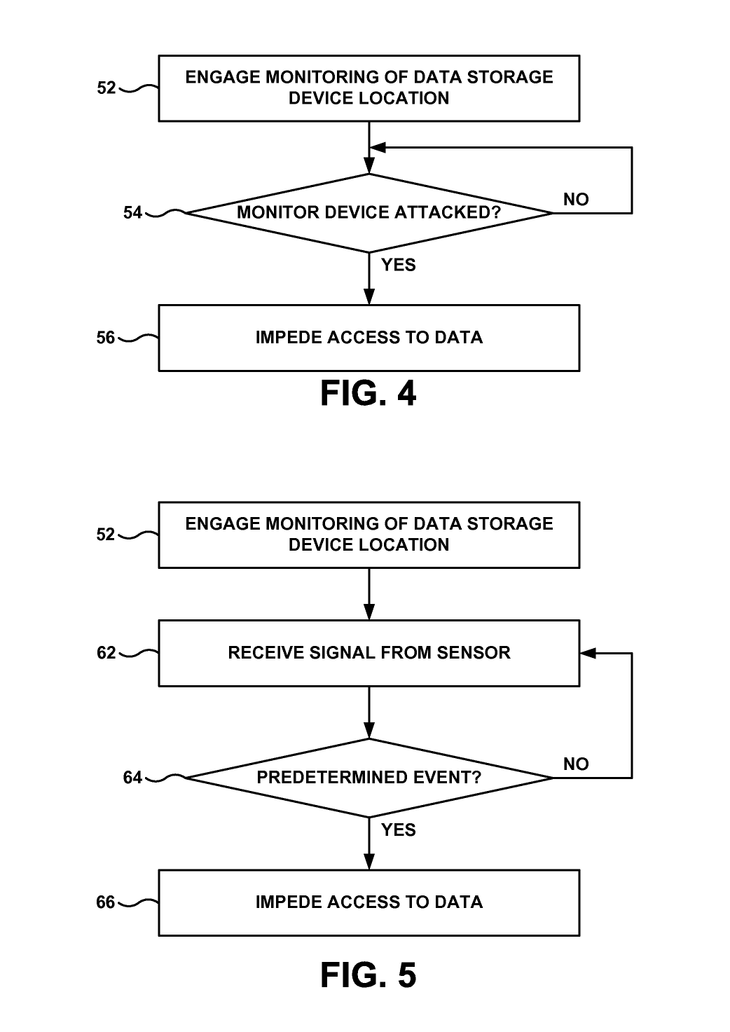

FIG. 4 is a flow diagram that illustrates an example of a technique according to which a monitor device 12 may protect data stored by a data storage device 14. FIG. 4 will be described with concurrent reference to system 10 and monitor device 12 of FIGS. 1-3 for clarity. However, it will be appreciated that the technique illustrated in FIG. 4 is not limited to being implemented by such systems and may be performed by another system. In the example of FIG. 4, processor 32 of monitor device 12 is engaged (e.g., activated or turned on) to monitor the location in which data storage device 14 is disposed, e.g., physical domain 18, 22 and/or areas near physical domain 18, 22 (52). As described above, processor 32 may monitor physical domain 18, 22 and/or an area near physical domain 18, 22 based on signals received from sensor 16 via sensing module 40. In some examples, processor 32 may be engaged to monitor the location by a user who interacts with user interface 42.

Processor 32 also monitors a signal generated by a sensor 16 or may execute a software or firmware program to determine if an attacker is attacking monitor device 12 (54). As described above, the attacker may attack monitor device 12 using a physical attack and/or an electronic attack. In some examples, system 10 may include a sensor 16 that is configured to sense physical attacks on monitor device 12, and processor 32 may receive signals from the sensor 16 and determine if monitor device 12 is being attacked based on the signals. For example, a sensor 16 may be located within or on a housing of monitor device 12 and may detect physical tampering with monitor device 12, e.g., opening of the housing, movement of the housing, or damage to the housing.

In other examples, a sensor 16 that is separate from monitor device 12 may be configured to sense physical attacks on monitor device, and processor 32 may receive signals from the sensor 16 and determine if monitor device 12 is being attacked based on the signals. For example, sensor 16 may include a motion sensor or a video camera that is directed toward the physical area in which monitor device 12 is located, and processor 32 may receive signals generated by sensor 16 and determine whether an attacker is attacking monitor device 12 based on these signals. For example, processor 32 may execute an algorithm to determine whether the video images captured by the video camera have captured motion within the physical domain 18, or have captured an image of an attacker.

In some examples, processor 32 may additionally or alternatively execute a software or firmware program that monitors electronic access to monitor device 12 and determines if an attacker is attempting to electronically attack monitor device 12. For example, processor 32 or another module of monitor device 12 may produce a signal or a signal processing integrity characteristic that is altered when an attacker electronically attacks monitor device 12. As processor 32 executes operations of a software program that provides functionality of monitor device 12, the performance of the operations may change as a result of change to the signal or signal processing integrity characteristic. Processor 32 or a software or firmware program executed by processor 32 may detect the change in the performance of the operations and interpret the change as an indicating an electronic attack on monitor device 12.

In any case, if processor determines that an attacker has not attacked monitor device 12 (the “NO” branch of box 54), processor 32 may continue to periodically determine whether an attacker has attacked monitor device 12 (54). However, when processor 32 determines that an attacker has attacked monitor device (the “YES” branch of box 54), the processor 32 may perform an action to impede access to data stored by data storage device 14 (56). As described above, such action may include, for example, disabling communication between monitor device 12 and data storage device 14, disabling communication between monitor device 12 and a device that stores a key or key split used to decrypt data stored by data storage device 14, rendering inaccessible to data storage device 14 a key or a key split used to decrypt data stored by data storage device 14, disabling communication between monitor device 12 and a device that stores a key or key split used to decrypt data stored by data storage device 14, and/or sending an instruction to data storage device 14 to delete data stored by data storage device 14. As described above, rendering inaccessible to data storage device 14 a key or a key split used to decrypt data stored by data storage device 14 may include deleting the key or key split (e.g., a volatile key split 26).

FIG. 5 is a flow diagram that illustrates another example of a technique according to which a monitor device may protect data stored by a data storage device. Similar to FIG. 4, the technique shown in FIG. 5 will be described with concurrent reference to system 10 of FIG. 1 and monitor device 12 of FIGS. 1-3, although the technique illustrated in FIG. 5 may also be performed by other systems.

In accordance with the technique shown in FIG. 5, processor 32 of monitor device 12 is engaged to monitor a location in which data storage device 14 is disposed, e.g., physical domain 18, 22 and/or areas near physical domain 18, 22 (52).

Processor 32 of monitor device 12 then receives, via sensing module 40, signals from sensor 16 (62) and determines whether the signals indicate the occurrence of a predetermined event in the area covered by sensor 16 (64). Sensor 16 may include, for example, a magnetic sensor, a motion sensor, a pressure transducer, an acoustic sensor, or an optical sensor. As described above, sensor 16 may be located within physical domain 18, along a perimeter of physical domain 18, or outside of physical domain 18, and may sense events within physical domain 18, near a perimeter of physical domain 18, or in an area outside of physical domain 18.

As described above, the predetermined event may include an event that suggests that an attacker is attempting to access physical domain 18 and/or data storage device 14. To facilitate the determination of whether a predetermined event has occurred or is occurring, processor 32 may in some examples determine a baseline value or threshold value for the signal received from sensor 16, e.g., when monitor device 12 is first engaged and physical domain 18, 22 is known to not be accessed by an attacker (e.g., physical domain 18, 22 is in a known protected state). Processor 32 may determine the baseline value or threshold value based on a value extracted from the signal received from sensor 16, e.g., may determine an average value of the received signal over some time duration. In other examples, characteristics of the signal received from sensor 16 that may trigger an action by monitor device 12 may be predetermined and stored in a memory 34 of monitor device 12.

When processor 32 determines based on the signal received from sensor 16 that a predetermined event has not occurred (the “NO” branch of decision box 64), processor 32 may continue to receive signals from sensor 16 (62) and determine whether the signals indicate occurrence of a predetermined event (64). However, when processor 32 determines that a predetermined event has occurred or is occurring (the “YES” branch of decision box 64), processor 32 may perform an action to impede access to data stored by data storage device 14 (66). For example, processor 32 may generate an alarm, which may include an audible alarm, a visual alarm, or the like, and may additionally or alternatively communicate an alarm to security persons, police, or the like.

In some examples, processor 32 may additionally or alternatively perform an action to physically secure data storage device 14, such as causing a door to a room within physical domain 18 (when physical domain 18 is a building) in which data storage device 14 is located to lock. As another example, processor 32 may physically secure data storage device 14 by causing an electronic enclosure in which data storage device 14 is disposed to lock.

In some implementations, when processor 32 determines that a predetermined event is occurring or has occurred (the “YES” branch of decision box 64), processor 32 may in some examples perform an action to electronically secure the data stored on data storage device 14 in addition to or as an alternative to an alarm or physically securing data storage device 14 to impede access to data (66). For example, processor 32 may communicate an instruction to data storage device 14 that causes data storage device 14 to delete the data. As another example, processor 32 may cause a key used to decrypt the data to be deleted or rendered inaccessible to data storage device 14. In some examples, access of the data stored on data storage device 14 may be contingent on communication between data storage device 14 and monitor device 12, e.g., data storage device 14 may retrieve at least one encryption key from monitor device 12 to decrypt the data, and processor 32 may disable communication between monitor device 12 and data storage device 14 upon determining that the predetermined event has occurred or is occurring.

While the examples described above have primarily been directed to systems implemented on a scale of a room or building, in other examples, the systems and techniques described herein may be applied to protect data stored on a data storage device located within other physical domains. FIG. 6 is a conceptual block diagram that illustrates an example of such a system and physical domain. The physical domain shown in FIG. 6 may be on a smaller scale than a room or building.

The system 70 of FIG. 6 includes a substrate 72 on which a data storage device 78 is mounted. Data storage device 78 is at least partially enclosed within enclosure 74. Enclosure 74, in combination with substrate 72, defines physical domain 76. Also located within physical domain 76 are monitor device 80, sensor 82, and a memory 84 that stores a volatile key split 84 in some examples. In the example illustrated in FIG. 6, monitor device 80 is communicatively coupled with data storage device 78 via electrical connection 86, is communicatively coupled with sensor 82 via electrical connection 88, and is communicatively coupled with memory 84 via electrical connection 90.

In some examples, system 70 may be a portion or a component of a larger system. For example, system 70 may be a printed board assembly (PBA), and substrate 72 may be a printed board (PB). In some implementations, the PBA may be electronically coupled to a master interconnect board (MIB) as part of a larger electronics system. In other examples, system 70 may be a MIB (e.g., a motherboard) and substrate 72 may be a PB. In some examples in which substrate 72 is a PB, at least one of electrical connections 86, 88, 90 may be electrical traces formed on a surface (e.g., top surface 92) of the PB or on a plane within the PB.

In other examples, substrate 72 may be another type of material, such as a metal, plastic, or ceramic material, and may or may not include electrical interconnections between data storage device 78 and at least one other electronic component. In any case, data storage device 78 may be attached to substrate 72, e.g., via soldering, an adhesive, or the like.

Although enclosure 74 is illustrated in FIG. 6 as contacting top surface 92 of substrate 72 and being attached to top surface 92, in other examples, enclosure 74 may partially enclose substrate 72 or may substantially fully enclose substrate 72. Moreover, enclosure 74, together with substrate 72, may partially enclose data storage device 78 or substantially fully enclose data storage device 78. In some examples, enclosure 74 may define one or more openings that facilitate electrical connection between substrate 72 and another component and/or between data storage device 78 and another component. For example, enclosure 74 may define an opening through which a flexible circuit may protrude to electrically connect substrate 72 to another component. In other examples, enclosure 74 may not directly contact substrate 72 and a spacer may be positioned between enclosure 74 and substrate 72. Furthermore, the relative size of substrate 72 and enclosure 74 shown in FIG. 6 is one example; in other examples, substrate 72 and enclosure 74 can have any suitable relative size. However, enclosure 74 is size to at least partially enclose data storage device 78, and, in some examples, substantially full enclose data storage device 78 on substrate 72.

Although not shown in FIG. 6, in some examples, enclosure 74 may include an integrated sensor or a sensor attached to a surface of enclosure 74. For example, enclosure 74 may include or be attached to a sensor (e.g., a pressure sensor) that detects a force exerted on enclosure 74, e.g., when an attacker is attempting to separate enclosure 74 from substrate 72. In other examples, the sensor integrated into enclosure 74 or attached to enclosure 74 may include a sensor that detects deformation of enclosure 74, such as a strain sensor or a fiber optic cable that may be damaged when enclosure 74 is damaged.

Enclosure 74 may be formed of a flexible, semi-rigid, or substantially rigid material. In some examples, enclosure 74 may be formed of a polymer body that is at least partially covered with a metal shield. For example, the metal shield may cover at least a portion of an outer surface of the polymer (a surface facing away from substrate 72). The metal shield may contribute to the robustness of the enclosure in some implementations. Additionally or alternatively, the metal shield may provide desirable thermal characteristics, such as contributing to conduction of heat away from data storage device 78 or another electronic component within physical domain 76 to the outside of enclosure 74.

In some examples, as described briefly above, enclosure 74 may include an integrated sensor or an attached sensor that a processor of system 70 can use to detect tampering with enclosure 74. For example, the sensor may include one or more conductive traces printed on a surface of enclosure 74, one or more wires brazed or otherwise attached to a surface of enclosure 74, or one or more fiber optic elements attached to a surface of enclosure 74. In any of these examples, the surface of enclosure 74 to which the sensor is attached may be an inner surface of enclosure 74 (facing toward substrate 72) or an outer surface of enclosure 74 (facing away from substrate 72). The types of sensors listed herein as capable of being attached to or integrated with enclosure 74 are merely examples, and other sensors may also be utilized.

Data storage device 78 is located within physical domain 76 and is at least partially enclosed by enclosure 74 and substrate 72. Data storage device 78 may include any of the storage media described herein, for example, with respect to FIGS. 1 and 2. In the example illustrated in FIG. 6, data storage device 78 includes a solid state storage device, such as DRAM, SRAM, ROM, PROM, EPROM, EEPROM, flash memory, FeRAM, MRAM, or the like. In some examples, substrate 72 is a PB, and data storage device 78 may be electrically connected to electrical traces formed on a surface of the PB or on a plane within the PB. In the example illustrated in FIG. 6, data storage device 78 is electrically connected to monitor device 80 via electrical connection 86, which may be an electrical trace.

As described above, in some examples, data storage device 78 is configured to store data (e.g., intellectual property) that a user may wish to be protected. In some examples, to aid in protecting the data, the data may be encrypted and may require a key to decrypt the data into intelligible form (e.g., a form that is understandable/intelligible to a human or machine), which, along with system 10, may provide protection to the stored data.

System 70 is configured to protect data stored by data storage device 78 by impeding access to the data by an unauthorized user (also referred to herein as an attacker). In some examples, monitor device 80 is able to be engaged and disengaged (e.g., turned on and off, respectively). When disengaged, monitor device 80 may not monitor the output of sensor 82, or may monitor the output of sensor 82 but may not perform any action based a signal received from sensor 82. When engaged, however, monitor device 80 monitors signals received from sensor 82, and may perform an action based on a signal received from sensor 82. Monitor device 80 may be similar to monitor device 12 (FIG. 1) in some examples. Similarly, sensor 82 may be similar to sensor 16 (FIG. 1) in some examples.

In some examples, sensor 82 comprises any one or more sensors that monitor at least one parameter of physical domain 76. The one or more sensors may each generate a signal indicative of at least one parameter of physical domain 76, and a processor of monitor device 80 may detect unauthorized access to physical domain 76 (e.g., breach of enclosure 74) based on the signal. For example, sensor 82 may include a magnetic sensor that monitors a status of enclosure 74, e.g., whether enclosure 74 is in an open state (i.e., is breached) or a closed state. As another example, sensor 82 may include a pressure transducer, which may sense pressure at one or more points within physical domain 76, e.g., to determine whether enclosure 74 has been deformed or removed (i.e., is breached). Sensor 82 may be electrically connected to monitor device 80 via electrical connection 88. Although only a single sensor 82 is illustrated in FIG. 6, in other examples, system 70 may include more than a single sensor 82. When system 70 includes more than one sensor, the multiple sensors may be the same type or different types. Additionally, in some examples, system 70 may include sensors disposed outside of physical domain 76 (i.e., outside of enclosure 74), although sensor 82 is depicted inside enclosure 74.

Monitor device 80 receives signals from sensor 82 via electrical connection 88 and, in some examples, determines, based on the signals, whether a predetermined event is occurring or has occurred in a location in which sensor 82 covers. The predetermined event may include an event that suggests or indicates that an attacker is attempting to access physical domain 76 and/or data storage device 78. For example, sensor 82 may include a pressure sensor attached to enclosure 74, and monitor device 80 may determine when the signal generated by sensor 82 indicates that the enclosure 74 has been deformed or removed.

When monitor device 80 determines that a predetermined event is occurring or has occurred, monitor device 80 may in some examples perform an action (e.g., directly perform the action or control another device to perform the action) to electronically secure the data stored on data storage device 78. For example, monitor device 80 may communicate an instruction to data storage device 78 that causes data storage device 78 to delete the data. As another example, monitor device 78 may cause a key used to decrypt the data to be deleted or rendered inaccessible to data storage device 78. The key or a key split may be stored in a memory of monitor device 80 and/or memory 84. In some examples, a volatile key split is stored in memory 84 and a hard key split is stored in a memory of monitor device 80, similar to the configuration described above with respect to FIG. 2. In some examples, access of the data stored on data storage device 78 may be contingent on communication between data storage device 78 and monitor device 80, e.g., data storage device 78 may retrieve at least one encryption key from monitor device 80 to decrypt the data, and monitor device 80 may disable communication between monitor device 80 and data storage device 78 upon determining that the predetermined event has occurred or is occurring.

System 70 also provides protection to data stored by data storage device 78 when monitor device 80 is attacked or when operation of monitor device 80 fails, such as when monitor device 80 loses power or is otherwise rendered incapable of monitoring physical domain 74 and/or data storage device 78. System 70 may provide protection to data stored by data storage device 78 when monitor device 80 detects an attempted attack on monitor device 80 and/or when an attacker makes a successful attack on monitor device 80 (e.g., by modifying operation of monitor device 80, disabling monitor device 80, or damaging monitor device 80). For example, monitor device 80 may condition access to data stored by data storage device 78 based on communication between monitor device 80 and data storage device 78.

In some examples, an attacker attempting to access the data stored by data storage device 78 may be aware that monitor device 80 is monitoring physical domain 74 or an area near physical domain 74 to protect data storage device 78, and may attempt to disable monitor device 80 to facilitate access to data stored by data storage device 78. The attacker may attack monitor device 80 with a physical attack and/or an electronic attack. A physical attack may include, for example, physical damage to or destruction of monitor device 80, may include cutting off a power source to monitor device 80, or may include attack of one or more communication connections between monitor device 80 and another device (such as data storage device 78, sensor 82, or memory 84). An electronic attack may include, for example, damage or disabling of one or more functions performed by monitor device 80 via a modification of software or firmware executed by a processor of monitor device 80.

Regardless of the precise nature of the attack on monitor device 80, system 70 (e.g., including monitor device 80 and data storage device 78) is configured so that access to the data stored by data storage device 78 is conditioned based on communication between monitor device 80 and data storage device 78, and access to the data is impeded when monitor device 80 is attacked or operation of monitor device 80 otherwise fails.

In one example, data storage device 78 is configured to communicate with monitor device 80 before allowing access to the data, as described above. Thus, if operation of monitor device 80 fails data storage device 14 may not be able to communicate with monitor device 80. In response, data storage device 78 may restrict access to the data, e.g., by not allowing any access to the data, by deleting the data, or by maintaining the data in an encrypted state, which may impede the attacker (or another device or person) from accessing the data. Similarly, if an attacker electronically attacks monitor device 80 and modifies or disables a communication module executed by a processor of monitor device 80 to communicate with data storage device 78 and/or other external electronic devices, data storage device 78 may not be able to communicate with monitor device 80 and may restrict access to the data, which may impede the attacker (or another device or person) from accessing the data.

In other examples, monitor device 80 may detect a physical or electronic attack and may perform an action in response to detecting the attack, as described above. For example, monitor device 80 may include one or more sensors (which may include sensor 82) that are configured to detect a physical attack, e.g., an accelerometer to detect motion or orientation of monitor device 80, a magnetic sensor to detect whether a housing or enclosure of monitor device 80 (or enclosure 74) is opened, a pressure transducer to detect a force exerted on monitor device 80 or enclosure 74, or the like. Monitor device 80 may additionally or alternatively include a software or firmware program executed by a processor of monitor device 80 that detects an electronic attack of monitor device 80.

Regardless of how monitor device 80 detects the attack on device 80 or whether the attack is a physical attack or an electronic attack, monitor device 80 may perform an action to impede access to the data stored by data storage device 78 when device 80 detects the attack. For example, monitor device 80 may disable communication between data storage device 78 and monitor device 80 upon detecting an attack upon monitor device 80. As another example, monitor device 80 may render a key used to decrypt data stored by data storage device 78 inaccessible to data storage device 78, e.g., by deleting the key or disabling communication between monitor device 80 and data storage device 78.

In other examples, monitor device 80 is configured so that operational failure of monitor device 80, e.g., due to a loss of power, or an attack on monitor device 80 automatically impedes access to the data stored by data storage device 78. For example, monitor device 80 may store a key used to decrypt encrypted data stored by data storage device 78 in a manner that causes the key to be lost automatically upon failure of or an attack on monitor device 80. As an example, monitor device 80 may store the key in memory that is positioned within the housing or enclosure of monitor device 80 so that the memory is physically damaged and the key deleted or rendered inaccessible upon physical attack of monitor device 80 or enclosure 74. As another example, monitor device 80 may store the key in volatile memory that requires periodic refresh to maintain the contents of the memory, i.e., the key. When a failure (e.g., loss of power or a successful physical or electronic attack) causes monitor device 80 to operate incorrectly or turn off, the contents of the memory may no longer be refreshed and the key may thus be automatically deleted.

In some examples, similar to the example of FIG. 2, monitor device 80 may store in a memory a hard key split and a volatile key split may be stored in memory 84. Data storage device 78 may use the hard key split and volatile key split together to decrypt encrypted data stored by data storage device 78. In some examples, when a user requests encrypted data from data storage device 78, data storage device 78 communicates a request to monitor device 80 for monitor device 80 to access the memory that stores the hard key split and memory 84 that stores the volatile key split, retrieve the key splits, and communicate the key splits to data storage device 78.

System 70 is configured so that when operation of monitor device 80 fails, such as when monitor device 80 loses power or is successfully attacked, or when monitor device 80 detects a physical or electronic attack, the volatile key split stored in memory 84 is rendered inaccessible to data storage device 78, thus impeding decryption of data stored by data storage device 78. Similar to FIG. 1, in some examples, monitor device 80 may take an action upon detecting an attack on monitor device 80, such as disabling a communication module (e.g., communication module 36 described with respect to FIG. 3) that facilitates communication between monitor device 80 and data storage device 78. Alternatively or additionally, monitor device 80 may disable a communication module that facilitates communication between monitor device 80 and memory 84.

In other examples, when monitor device 80 detects an attack, monitor device 80 may communicate an instruction to a controller of memory 84 to delete the volatile key split.

In some examples, the volatile key split may be maintained in memory 84 based on a periodic communication between monitor device 80 and the controller of memory 84. For example, monitor device 80 may periodically communicate an instruction to the controller of the memory to refresh the contents of the memory to preserve volatile key split 26 (in the case of volatile memory). As another example, monitor device 80 may periodically communicate an instruction to the controller to not delete the volatile key split from memory 84. In either case, the controller may cause the volatile key split to be deleted from memory if the controller does not receive the instruction from monitor device 80 at a predetermined time or after a predetermined duration of time following the previous instruction from monitor device 80 that caused the volatile key split to be maintained in memory 84.

Hence, in some examples, monitor device 80 may cease communicating the instruction to the controller of the memory that stores the volatile key split when operation of monitor device 80 fails, such as when monitor device 80 loses power, or when monitor device detects an attack on monitor device 80. This may cause the controller to delete the volatile key split from memory 84. This method of causing deletion of volatile key split may be effective when monitor device 80 fails in one of multiple manners, e.g., if monitor device 80 loses power, if monitor device 80 is no longer able to communicate with the controller of the memory due to physical or electronic severing of the communication link, or if monitor device 80 is physically damaged or destroyed.

Although various features have been described with reference to different examples in this disclosure, these features may be utilized in any combination, and are not limited to the specifically described examples.

The techniques described in this disclosure, including those attributed to monitor devices 12, 80, data storage devices 14, 78, sensors 16, 82, the memory that stores hard key split 24, the memory that stores volatile key split 26, or other devices or elements such as modules, units or components of such devices, may be implemented, at least in part, in hardware, software, firmware or any combination thereof. Even where functionality may be implemented in part by software or firmware, such elements will be implemented in a hardware device. For example, various aspects of the techniques may be implemented within one or more processors, including one or more microprocessors, DSPs, ASICs, FPGAs, or any other equivalent integrated or discrete logic circuitry, as well as any combinations of such components, embodied in programmers, such as physician or patient programmers, stimulators, or other devices. The term “processor” or “processing circuitry” may generally refer to any of the foregoing circuitry, alone or in combination with other circuitry, or any other equivalent circuitry.

Such hardware, software, or firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

When implemented in software, the functionality ascribed to the systems, devices and techniques described in this disclosure may be embodied as instructions on a non-transitory computer-readable medium such as RAM, ROM, NVRAM, EEPROM, FLASH memory, magnetic data storage media, optical data storage media, or the like. The instructions may be executed to support one or more aspects of the functionality described in this disclosure.

Various examples have been described. These and other examples are within the scope of the following claims.

1. A system comprising:
a data storage device that stores data; and
a monitor device that monitors a physical domain in which the data storage device is located and conditions access to data stored by the data storage device based on communication between the monitor device and the data storage device, wherein the system is configured to impede access to the data when at least one of operation the monitor device fails or the monitor device is attacked.

2. The system of claim 1, wherein the monitor device is configured to restrict access to the data when the monitor device is engaged and an attacker attempts to access the data storage device directly.

3. The system of claim 2, further comprising a sensor configured to sense a characteristic of the physical domain in which the data storage device is located, wherein the monitor device receives a signal representing the characteristic of the physical domain from the sensor and restricts access to the data when the signal representing the characteristic of the physical domain indicates an occurrence of a predetermined event.

4. The system of claim 1, wherein the data stored by the data storage device comprises encrypted data, wherein the monitor device is configured to render a key, which provides access to the encrypted data, inaccessible to the data storage device when operation of the monitor device fails or when the monitor device is attacked.

5. The system of claim 4, wherein the monitor device comprises a memory that stores the key, and wherein the monitor device is configured to render the key inaccessible to the data storage device by deleting the key.

6. The system of claim 4, further comprising a memory that stores the key, wherein the memory is external to the monitor device and the data storage device, and wherein the monitor device is configured to render the key inaccessible to the data storage device by disabling communication between the monitor device and the memory.

7. The system of claim 4, wherein the monitor device is configured to render the key inaccessible to the data storage device by disabling communication between the monitor device and the data storage device.

8. The system of claim 1, wherein the data stored by the data storage device comprises encrypted data, wherein the monitor device is configured to render a volatile key split that provides access to the encrypted data inaccessible to the data storage device.

9. The system or claim 8, further comprising a memory remote from the monitor device and the data storage device, wherein the volatile key split is stored in the memory, and wherein the monitor device is configured to render the volatile key split inaccessible to the data storage device by disabling communication between the memory and the monitor device.

10. The system of claim 1, wherein failure of operation of the monitor device comprises at least one of loss of power, a successful electronic attack on the monitor device, or a successful physical attack on the monitor device.

11. A method comprising:
detecting an attack on a monitor device via at least one of a sensor or a software or firmware program; and
rendering a data storage device communicatively coupled to the monitor device unable to access a key when the attack on the monitor device is detected, wherein when the data storage device cannot access the key, access to encrypted data stored on the data storage device is substantially impeded.

12. The method of claim 11, wherein detecting the attack on the monitor device comprises detecting at least one of a physical attack or an electronic attack on the monitor device.

13. The method of claim 11, wherein rendering the data storage device unable to access the key when the attack on the monitor device is detected comprises deleting the key, which is stored in a memory of the monitor device.

14. The method of claim 11, wherein rendering the data storage device unable to access the key when the attack on the monitor device is detected comprises disabling communication between the monitor device and an external memory that stores the key.

15. The method of claim 11, wherein rendering the data storage device unable to access the key when the attack on the monitor device is detected comprises disabling communication between the monitor device and the data storage device.

16. The method of claim 11, wherein the key comprises a hard key split and a volatile key split, and wherein rendering the data storage device communicatively coupled to the monitor device unable to access the key when the attack on the monitor device is detected comprises rendering the monitor device unable to access the volatile key split when the attack on the monitor device is detected.

17. The method of claim 16, wherein rendering the monitor device unable to access the volatile key split when the attack on the monitor device is detected comprises disabling communication between the monitor device and a memory that stores the volatile key split.

18. The method of claim 11, further comprising monitoring, with the monitor device, a physical domain in which the data storage device is located.

19. A system comprising:
an enclosure;
a sensor configured to detect breach of the enclosure;
a data storage device at least partially enclosed within the enclosure; and
a monitor device configured to condition access to data stored by the data storage device based on communication between the monitor device and the data storage device, and wherein the system is configured to impede access to the data when at least one of operation the monitor device fails, the monitor device is attacked, or the enclosure is breached.

20. The system of claim 19, wherein the data storage device stores encrypted data, wherein monitor device comprises a memory that stores a key with which the data storage device decrypts the encrypted data, and wherein the monitor device deletes the key upon at least one of detecting a breach of the enclosure, upon detecting an attack on the monitor device, or upon losing power.
